(19) United States
(12) Patent Application Publication
(10) Pub. No.: US 2005/0115520 A1
(43) Pub. Date: Jun. 2, 2005

(54) Dog leash provided with a rigid handle including means for collecting and disposing of the animals excrements

(76) Inventor: Vasco Mancini, Montevarchi (IT)

Correspondence Address: STEINBERG & RASKIN, P.C., 1140 AVENUE OF THE AMERICAS, 15th FLOOR, NEW YORK, NY, 10036-5803, US

(21) Appl. No.: 10/505,614

(22) PCT Filed: Dec. 17, 2002
(86) PCT No.: PCT/IT02/00796

(30) Foreign Application Priority Data
Feb. 20, 2002 (IT) FI2002U000019
Apr. 15, 2002 (IT) FI2002U000039

(51) Int. Cl. A01K 27/00

(52) U.S. Cl. 119/796

(57) ABSTRACT

A leash is disclosed, which comprises a wire-shaped or band-shaped, relatively flexible member with a first end for attachment to a pet collar or harness, and a handle for grasping the other end of the wire-shaped or band-shaped member. The leash handle has a relatively rigid body. The leash also includes a device for collecting animal excre-ment releasably connected to the rigid body so as not to interfere with normal use of the leash. Preferably, the device for collecting excrement comprises a scoop inserted flush within a seating formed in the body, a snap fastener being arranged between the seating and the scoop to secure the latter in the inserted position.

### FIELD OF THE INVENTION

The present invention relates to the field of the articles for the care of pets, namely dogs. More specifically, it relates to a new type of dog leash.

### DESCRIPTION OF THE PRIOR ART

It is well known how dog excrements, by soiling the sidewalks, and—more generally speaking—the streets and all the outdoor urban places, cause problems and discomfort to the people. Many attempts have been made in the past, even by means of strong press and advertising campaigns, for persuading the pet owners to collect and dispose of the excrements. To this purpose, various devices have been proposed which are capable of making things easier, that is to say of permitting an effortless collecting of the excrements, without any risks of getting the hands soiled.

However, the use of such devices, or of any other more basic tools (paper or plastic gloves and small bags) is quite rare. As a matter of fact, many people deem it annoying to carry a supplementary equipment with them, when taking the dog for a walk. Other people leave the equipment at home in most cases. Therefore, the laziness and carelessness prevail over the good manners and public spirit, and the problem remains unsolved.

### SUMMARY OF THE INVENTION

The present invention can contribute to the solution of the above mentioned problem, i.e. it can encourage the habit of collecting and disposing of the dog excrements by its owner taking it for a walk.

In fact, according to the present invention there is provided a dog leash comprising a wire-shaped or band-shaped flexible member with a first end to be fixed to a collar or harness of a dog, and grip means for gripping the other end of the wire-shaped or band-shaped member, characterized by the fact that said grip means comprise a rigid body, and by the fact that the leash comprises also means for collecting the dog excrements, releasably connected to the rigid body so as not to disturb the normal use of the leash.

Thanks to the leash according to the invention, one gets rid of the discomfort of carrying supplementary collection equipment, because everything needed for collecting and disposing of the excrements is built-in with the leash. At the same time, there is no longer a possibility of leaving the equipment at home.

According to a preferred embodiment, the leash is an automatic one, i.e. a leash in which the rigid body has a box-like structure defining a cavity that houses a wire-shaped or band-shaped member, which is wound and unwound automatically, thanks to elastic return means. In this case it is the said body, which is already present in the ordinary automatic leashes, that is exploited for providing a support to the means for collecting the excrements. As an alternative, the normal wire-shaped or band-shaped member which a common non-automatic leash is made up of, is provided with an additional rigid grip body, with the aim of permitting the integration of the means for collecting and disposing of the excrements.

In all cases, advantageously, such collecting means comprise a scoop, which is inserted flush in a seating formed in said body. Snap engagement means are arranged between the seating and the scoop, in order to secure the latter in the inserted position. The scoop may advantageously have a flat bottom which, in the inserted position, is perfectly coplanar to a flat face of the body in which the insertion seating is formed. In this way, the bottom of the scoop and the bottom of the seating define a housing for some small bags to be filled with the excrements so as to facilitate the disposal thereof. The small bags are preferably arranged in a suitable box. Still according to a preferred embodiment, the scoop comprises a handle piece which, when the scoop is inserted, couples with an handle piece which is integral to the body, forming the actual grip handle of the leash.

When the above mentioned preferred embodiments are chosen, the leash becomes particularly practical and handy, it can be manufactured easily and inexpensively, and is esthetically pleasant, due to its being plain, light and compact. The habit of collecting and disposing of the excrements of one's own pet cannot but be remarkably encouraged.

### BRIEF DESCRIPTION OF THE DRAWINGS

Other characteristics and advantages of the new leash according to the present invention will be apparent from the following description of an embodiment thereof, to be intended as an example and not limitative, with reference to the attached drawings, in which:

FIG. 1 is a schematic perspective view of a grip body of a leash of the automatic type according to the invention, in an assembled configuration;

FIG. 2 is a schematic perspective view of the body of FIG. 1, in an exploded configuration;

FIG. 3 is a plan view, seen from the exterior, of a shell portion of the body of the previous figures, deprived of the scoop and of a bag-holding box;

FIG. 4 is a side elevation of the shell portion of FIG. 3, seen from the side of the handle piece;

FIG. 5 is a plan view, seen from the exterior, of the scoop to be coupled with the shell portion of FIGS. 3 and 4;

FIG. 6 is a side elevation of the scoop of FIG. 5, seen from the longitudinal side thereof; and

FIG. 7 is a top plan view of a bag-holding box to be inserted between the shell portion and the scoop of the previous figures.

### DETAILED DESCRIPTION OF THE INVENTION

Referring to said figures, the leash according to the invention comprises a wire-shaped or band-shaped flexible member to be connected with a first end to a collar or harness of a pet. The flexible member is neither described nor shown, been however perfectly analogous to the ones in the prior art. The leash comprises also a rigid body 1, to which the other end of the flexible member is connected.

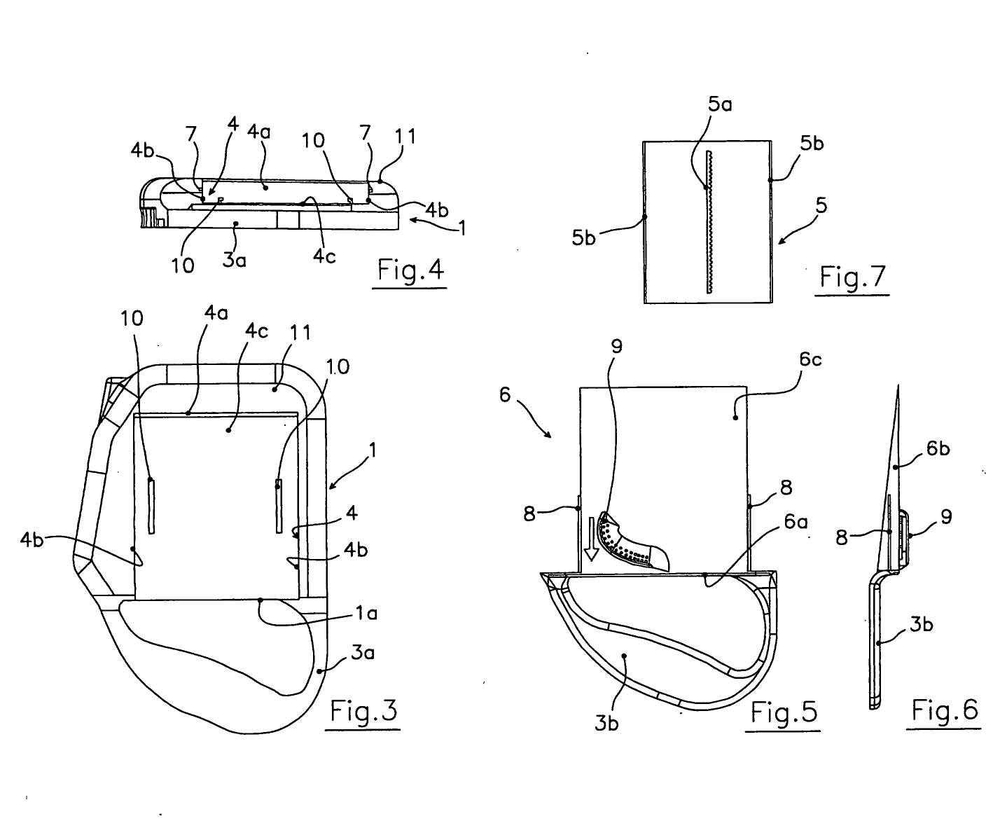

In the depicted embodiment, the leash is of the so-called “automatic” type, namely in which the flexible member is unwound from a pulley and automatically wound thereon thanks to elastic return means. Therefore, body 1 corresponds to the conventional box-shaped body which houses the pulley for winding/unwinding the flexible member. Body 1 is flattened, at right angle to the rotation axis of the pulley, thereby defining two main flat faces of which only one is visible in the figures and indicated at 11. Moreover, the body is made of two shell portions, cooperating with each other so as to define the cavity which houses the pulley assembly. Only the shell portion that comprises flat face 11 is represented in FIGS. 3 and 4.

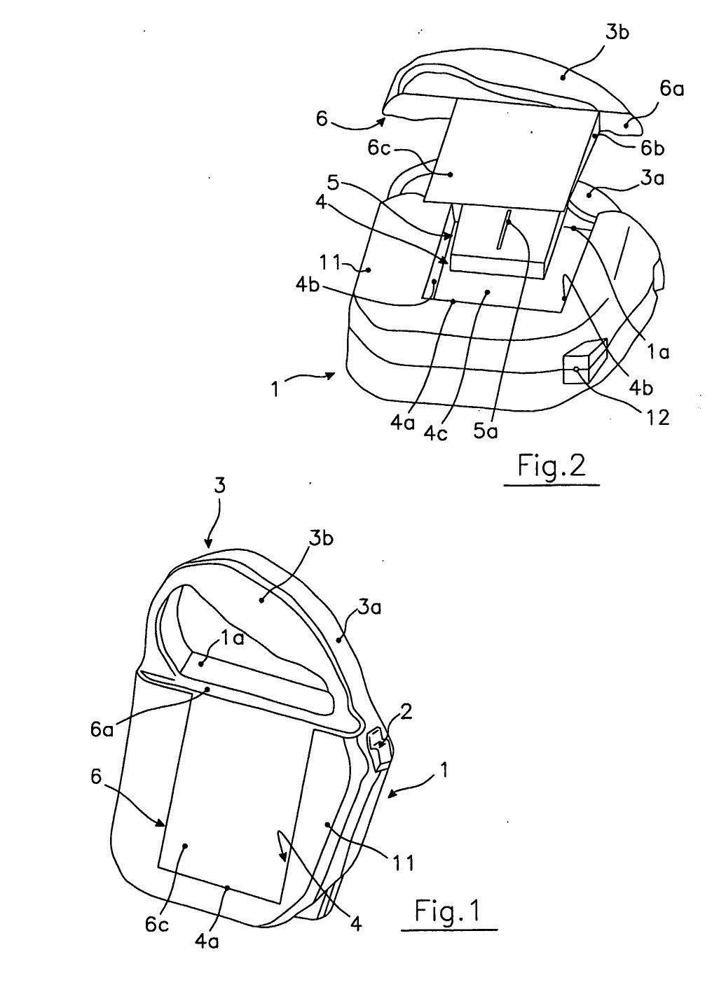

The pulley, the flexible member to be connected to the collar or the harness of the pet, and all the other supplementary components, namely the elastic return means which drive the pulley for automatically winding the flexible member, are neither described nor shown in the figures, being however the same as in the known automatic leashes. Only in FIG. 1, on a longitudinal side of body 1 there is visible a button 2 for unlocking the rotation of the pulley. Still in FIG. 1, there is also visible an outlet hole of the flexible member from body 1, indicated at 12.

A handle piece 3a, described in a better way further on, integrally projects from a side 1a of body 1, still over the flattening plane of the same body. A seating 4 is formed in face 11 and has a quadrilateral outline when seen from a direction which is normal to the face. More precisely, seating 4 runs from side 1a of body 1—i.e. the side which is adjacent to handle piece 3a—to an opposite edge indicated at 4a. Seating 4 is open along side 1a, above and beyond over face 11, defining a flat bottom 4c and opposite longitudinal side walls 4b.

A scoop 6, shown in particular in FIGS. 4 and 5, has the same overall shape of seating 4, with a flat bottom 6c corresponding to bottom 4c, longitudinal side walls 6b (having a triangular outline in the example) which project from two opposite sides of bottom 6c, and a transverse wall 6a, in turn projecting from a side of bottom 6c between the two longitudinal side walls 6b. Transverse wall 6a is fit for obstructing completely the opening of seating 4 over the side of the handle piece 3a.

Thus, scoop 6 is engageable within seating 4, by inserting it through the opening over side 1a, and making it slide down the length of body 1 with longitudinal side walls 6b placed adjacently to side walls 4b of seating 4, and with bottom 6c placed coplanarly to flat face 11. To this purpose, guide slots 7 and protrusions 8, designed for mutual engagement, are formed along the longitudinal side walls 4b and 6b, respectively. Snap engagement means, not shown, e.g. consisting of end enlargements of protrusions 8 and corresponding cutouts in slots 7, lock scoop 6 in the position of complete insertion, shown in FIG. 1, in which the scoop stops against edge 4a of seating 4. In such figure, it can be noticed that bottom 6c and transverse wall 6a of scoop 6 completely close seating 4, so that the outer surface of body 1 becomes continuous and regular.

From transverse wall 6a, which is elongated on side 1a of body 1 beyond the two longitudinal side walls 4b of seating 4, there extends outwardly a handle piece 3b. Handle piece 3b is integral to transverse wall 6a and has the same shape of handle piece 3a of body 1. The two handle pieces 3a and 3b mutually couple when the scoop is inserted (FIG. 1) so as to form an actual grip handle 3 of the leash.

When scoop 6 is inserted, bottom 6c and bottom 4c of seating 4 are mutually spaced. In this way, there is defined a closed housing which can be used for containing further equipment for assisting the operations of collecting and disposing of the excrements, namely and typically some disposable small bags made of paper, synthetic material or any other suitable material.

Advantageously, said bags are arranged within a suitable box 5 similar to that which can be seen in FIG. 2 and is shown by itself in FIG. 6. Box 5 can be secured to bottom 4c of the seating 4 thanks to lips 5b projecting sideways therefrom and engaging with protrusions 10 rising from bottom 4c. Thanks to a slot 5a having a saw-like edge, the bags, not shown, can be pulled off the box, and torn away from a band with partial cut lines, suitably arranged within the box. Bands of the above mentioned kind will be made available on the market, so as to be easily re-loaded in box 5 from an opening (not visible), once run out. As an alternative, when the bags have run out, box 5 will be disposed of, and replaced by a new box loaded with bags, available on the market to the purpose.

When scoop 6 is inserted, the leash will have therefore an appearance and a functionality entirely corresponding to those of an automatic leash according to the prior art. When scoop 6 has to be used, that is to say when the pet excrements have to be collected, it will be simply ejected by exerting a light manual force on the outer face of bottom 6c. In order to assist this operation, a projection 9 may be provided on said face, as visible in FIGS. 4 and 5.

Scoop 6, the handling of which is made easier thanks to its own handle piece 3b, can be used while the leash continues to perform its own normal functions. If scoop 6 is preliminarily lined with one of the disposable bags, the scoop and also the hand of the user will not get soiled by the excrements. In this respect, also disposable gloves may be arranged in the housing formed by scoop 6 and seating 4. When the excrements have been collected, the same bag lining the scoop, or a further one, will permit the disposal of the excrements, and scoop 6 will be secured back to body 1.

It will be easily appreciated how the leash according to the invention offers an extremely effective contribution to the solution of the problem mentioned in the introductory part of the present description. The whole assembly of body 1, scoop 6 and box 5 can be manufactured by using plastics, with molding operations of a conventional type.

The depicted embodiment, although advantageous under a plurality of viewpoints (handiness, pleasant appearance, cost-effective production), may undergo a number of constructive modifications within the scope of the same inventive concept, namely that of providing, in a dog leash, means for collecting and disposing of the animal excrements built-in with a rigid grip body of the leash.

In case of an automatic leash, like the one above described as an example, it will be the box-like rigid body which is already present, to be used for supporting the collecting means. However, the invention can be generally exploited in common leashes, that is to say the leashes merely formed by a flexible and inextensible member (made of leather, tissue, metal chain or plastics). In the latter case a supplementary rigid grip body will be resorted to, and the flexible member will be fastened to the outside of the supplementary body.

Variations and/or modifications can be brought to the dog leash provided with a rigid handle including means for collecting and disposing of the animal excrements according to the present invention without departing from the scope of the invention itself as defined by the appended claims.

1. A leash comprising a wire-shaped or band-shaped, relatively flexible member with a first end for attachment to a pet collar or harness, and a handle for grasping the other end of the member, wherein the handle has a relatively rigid body and has a scoop for collecting animal excrement releasably connected to the rigid body so as not to interfere with normal use of the leash.

2. The leash set forth in claim 1, wherein the scoop is inserted flush within a seating formed in the body, a snap fastener being arranged between the seating and the scoop for securing the later in an inserted position.

3. The leash set forth in claim 2, wherein the body has at least one relatively flat face, the seating being formed in the face and affecting a side of the body adjacent to the face, the opening on the allowing sliding insertion of the scoop within the seating, the scoop having a relatively flat bottom over the face.

4. The leash set forth in claim 3, wherein the seating has a generally quadrilateral outline, when viewed from a direction generally perpendicular to the face, the bottom having the same general quadrilateral outline as the seating, a relatively transverse wall projecting from a side of the bottom for completely obstructing the opening of the seating on the side.

5. The leash set forth in claim 3, wherein a grip the handle projects from the side of the side body affected by the seating.

6. The leash set forth in claim 5, wherein the scoop comprises a handle piece which, when the scoop is inserted, couples with a handle piece integral with the body so as to form the leash handle.

7. The leash set forth in claim 3, wherein the scoop comprises longitudinal side walls projecting generally at right angles from the bottom, the longitudinal side walls having protrusions for sliding engagement with slots formed in corresponding longitudinal side walls of the seating.

8. The leash set forth in claim 3, wherein an outer face of the bottom has a grip for assisting in the ejection of the scoop from the seating.

9. The leash set forth in claim 2, further comprising a disposable bag, such bag arranged in a housing formed by the seating and the scoop in the inserted position.

10. The leash set forth in claim 9, wherein the bag is arranged in a box releasably secured to a bottom of the seating.

11. The leash set forth in claim 10, wherein a slot with a generally saw-like edge is formed in the box in order to allow the bag to be pulled therefrom, and torn from a band with partial cut lines arranged within the box.

12. The leash set forth in claim 1, wherein the body has a box-like structure, housing a pulley for automatic winding/unwinding of the flexible member, driven by an elastic return.
